(19) United States
(12) Patent Application Publication
(10) Pub. No.: US 2026/0028048 A1
(43) Pub. Date: Jan. 29, 2026

(54) STATION-TIME SCENE REPRESENTATION FOR MACHINE LEARNING (ML)-BASED PLANNING

(71) Applicant: QUALCOMM Incorporated, San Diego, CA (US)

(72) Inventors: Vinay Kumar SENTHIL KUMAR, Philadelphia, PA (US); Paul Daniel MARTIN, Devon, PA (US); Pranav DESAI, San Diego, CA (US); Richard Stephen SHAFFER, Philadelphia, PA (US)

(21) Appl. No.: 18/781,277

(22) Filed: Jul. 23, 2024

(51) Int. Cl. B60W 60/00

(52) U.S. Cl. CPC B60W 60/00276

(57) ABSTRACT

Certain aspects of the present disclosure provide techniques for performing trajectory planning for an object, including: obtaining an ST scene representing 1) a displacement of one or more agents over time with respect to a reference point corresponding to a current position of the object and 2) a target location of the object; inputting the ST scene into a first machine learning model; outputting, by the first machine learning model, based on the input ST scene, a first target trajectory for the object to follow to occupy the target location; sending the first target trajectory to a second machine learning model; and obtaining, from the second machine learning model, a second target trajectory for the object to follow to occupy the target location.

### INTRODUCTION

### Field of the Disclosure

Aspects of the present disclosure relate to trajectory planning, and more particularly, to techniques for machine-learning based trajectory planning.

### DESCRIPTION OF RELATED ART

Autonomous vehicles have gathered significant attention in recent years due to their potential to revolutionize transportation and improve road safety. These vehicles rely on advanced perception, planning, and control systems to navigate through complex and dynamic environments without human intervention. One of the critical components of an autonomous vehicle is the trajectory planning system, which is responsible for generating safe, efficient, and feasible paths for the vehicle to follow.

Trajectory planning involves considering various factors, such as the vehicle’s dynamics, road geometry, traffic rules, and the presence of obstacles and other agents in the environment. In some aspects, vehicle dynamics may refer to the behavior and response of the vehicle in motion and take into account factors such as the vehicle's mass, acceleration, deceleration, and steering. In some aspects, agents, in the context of autonomous vehicles and trajectory planning, may refer to dynamic entities in an environment that can potentially interact with the autonomous vehicle, such as other vehicles, pedestrians, cyclists, or any other moving objects. The trajectory planner can generate trajectories that are not only collision-free but also optimize certain criteria, such as minimizing travel time, maximizing passenger comfort, or reducing energy consumption. Traditional approaches to trajectory planning often rely on rule-based systems, optimization algorithms, or search-based methods to generate feasible paths.

However, the complexity and uncertainty of real-world driving scenarios pose significant challenges to traditional trajectory planning methods. The environment in which an autonomous vehicle operates tends to be highly dynamic, with other vehicles, pedestrians, and obstacles constantly moving and interacting with each other. The autonomous vehicle needs to be able to perceive and predict the behavior of these dynamic objects and obstacles to make informed decisions. Additionally, the vehicle needs to be able to handle a wide range of driving situations, from structured highways to unstructured urban environments, and adapt to changing weather and lighting conditions.

To address these challenges, machine learning techniques have been explored for trajectory planning in autonomous vehicles. Machine learning algorithms have the ability to learn complex patterns and relationships from large amounts of data, making them well-suited for handling the high-dimensional and uncertain nature of driving environments. By leveraging the power of machine learning, autonomous vehicles can learn to perceive, reason, and make decisions in a way that mimics human-like intelligence.

### SUMMARY

One aspect provides a method for performing trajectory planning for an object. The method includes: obtaining an ST scene representing 1) a displacement of one or more agents over time with respect to a reference point corresponding to a current position of the object and 2) a target location of the object; inputting the ST scene into a first machine learning model; outputting, by the first machine learning model, based on the input ST scene, a first target trajectory for the object to follow to occupy the target location; sending the first target trajectory to a second machine learning model; and obtaining, from the second machine learning model, a second target trajectory for the object to follow to occupy the target location.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts a system for performing trajectory planning for an object in accordance with examples of the present disclosure.

FIG. 2 depicts details of a scenario and a corresponding station-time scene in accordance with examples of the present disclosure.

FIG. 3 depicts an example of a station-time scene in accordance with examples of the present disclosure.

FIG. 4 depicts a system for converting a scene representation into a station-time scene representation in accordance with examples of the present disclosure.

FIG. 5A depicts details of a local planner using a station-time scene in accordance with examples of the present disclosure.

FIG. 5B depicts details of training a machine learning model using a station-time scene and query in accordance with examples of the present disclosure.

FIG. 6 illustrates an example artificial intelligence (AI) architecture that may be used for AI-enhanced wireless communications.

FIG. 7 illustrates an example AI architecture of a first wireless device that is in communication with a second wireless device.

FIG. 8 illustrates an example artificial neural network.

FIG. 9 depicts an example method for performing trajectory planning for an object in accordance with aspects of the present disclosure.

FIG. 10 depicts aspects of an example processing system in accordance with aspects of the present disclosure.

### DETAILED DESCRIPTION

Aspects of the present disclosure provide apparatuses, methods, processing systems, and computer-readable mediums for generating trajectories, such as for autonomous vehicles or other objects. Though certain aspects are discussed with respect to trajectory generation for autonomous vehicles, it should be noted that the techniques discussed herein may be similarly applicable to other types of movable or moving objects.

In certain aspects, autonomous vehicles may rely on trajectory planning systems to navigate through complex and dynamic environments safely and efficiently. However, traditional planning methods often struggle to handle the high-dimensional and uncertain nature of real-world driving scenarios. That is, traditional planning methods may rely on rule-based systems or optimization algorithms which can be computationally expensive and may not scale well to complex scenarios with large amounts of data. As the complexity of the environment increases, the computational burden may also grow, making it difficult for traditional planning methods to provide outputs in real-time.

Furthermore, traditional planning methods may not be able to effectively handle the dynamic and uncertain nature of the environment, where the behavior of other agents is difficult to predict, leading to suboptimal or even unsafe trajectories. In particular, due to the complexity and uncertainty of an environment, the trajectory planner may need to consider a wide range of factors, such as the vehicle’s dynamics, road geometry, traffic rules, and the presence of other agents, while generating paths that are collision-free and optimize certain criteria, such as, but not limited to, minimizing travel time, maximizing passenger comfort, reducing energy consumption, ensuring smooth and stable vehicle motion, or maintaining a safe distance from other agents. Accordingly, there is a technical problem as to how to provide for computationally efficient and low latency trajectory planning that can handle complex scenarios in order to generate trajectories. In particular, vehicles may have limited processing power, and trajectories may need to be generated quickly, such as in real-time, in order to be useful for navigating a vehicle.

Certain aspects provide a trajectory planning framework that leverages the power of machine learning and a compact representation of the environment called a station-time (ST) scene. In certain aspects, the trajectory planning framework may address challenges with traditional trajectory planning methods. For example, in certain aspects, by representing the environment as an ST scene, the trajectory planning framework can reduce the computational complexity and memory requirements compared to traditional methods that often rely on high-dimensional state spaces. This compact representation allows for more efficient processing and faster generation of trajectories, enabling computationally efficient and low latency trajectory planning. In some aspects, machine learning techniques, such as deep neural networks, can learn complex patterns and relationships from large amounts of data, enabling the trajectory planning framework to handle uncertainty and variability that may be present in real-world driving scenarios more effectively than rule-based systems. In some aspects, the combination of machine learning techniques and the ST scene representation enables the trajectory planning framework to generate trajectories that are not only safe and efficient but also adaptable to various driving situations, as the learned models can generalize well to unseen scenarios. In particular, representing the environment as an ST scene may allow for computationally efficient and low latency generation of a trajectory. In some aspects, the trajectory planning framework enables the generation of trajectories that may be safe, efficient, and adaptable to various driving situations.

For example, certain aspects provide a hierarchical planning approach that combines the strengths of machine learning models with a compact spatiotemporal representation of the environment. In some aspects, a trajectory planning system may include a local planner and a global search model. In examples, the local planner may utilize an ST scene, which encodes the spatiotemporal relationships between the autonomous vehicle and other agents in a compact and efficient representation. In some aspects, the ST scene can serve as input to a machine learning model which generates short-term, collision-free trajectories that follow a global plan while adhering to vehicle dynamics constraints. Vehicle dynamics constraints may refer to limitations and characteristics of a vehicle's motion, such as, but not limited to, maximum acceleration, deceleration, steering angle, and velocity, which help to ensure that generated trajectories are feasible and safe for the vehicle to execute. The global search model can explore a larger search space and may consider long-term goals and constraints, such as, but not limited to, reaching a destination while minimizing travel time or fuel consumption, avoiding congested areas or road segments with known construction or closures, prioritizing routes that are safer or more comfortable for passengers, complying with traffic rules and regulations, and considering the vehicle's battery level or fuel status. The global search model can iteratively refine the trajectories generated by the local planner, taking into account factors such as the overall route, traffic conditions, and high-level navigation objectives. The global search model can employ search algorithms or optimization techniques to find a suitable path (e.g., optimal) from the vehicle’s current position to the target location.

Certain aspects of the trajectory planning framework may offer several benefits and advantages over traditional methods. In certain aspects, by leveraging machine learning models, the system may learn complex patterns and relationships from large amounts of data, enabling it to handle the high-dimensional and uncertain nature of driving environments. In certain aspects, the use of an ST scene may provide a compact and efficient representation of the environment, reducing the computational complexity and allowing for real-time planning. In certain aspects, the hierarchical approach, combining a local planner and a global search model, may enable the system to generate trajectories that are both locally feasible and globally refined (e.g., optimized). For example, in certain aspects, the local planner can focus on short-term safety and efficiency, while the global search model can consider long-term goals and constraints, resulting in trajectories that can be safe, smooth, and adaptable to various driving situations. Furthermore, certain techniques discussed herein may be flexible and capable of incorporating different machine learning architectures and search algorithms, allowing for customization and improvement based on specific requirements and advancements in the field.

### ASPECTS RELATED TO PERFORMING TRAJECTORY PLANNING

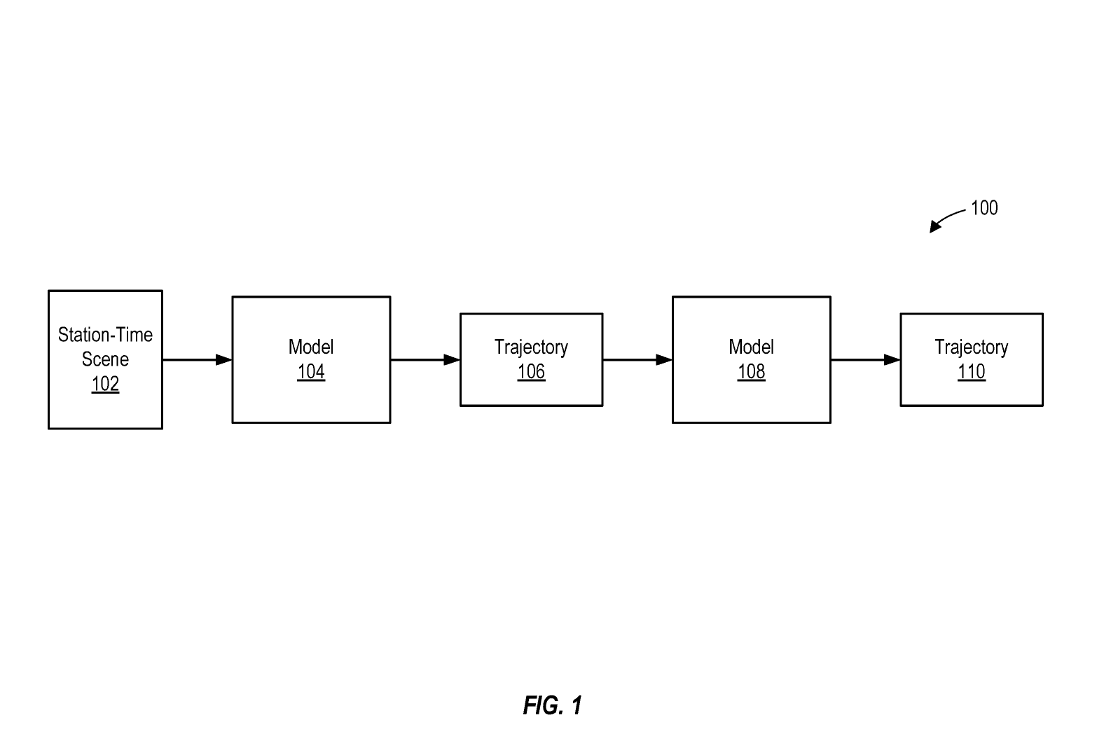

FIG. 1 depicts a system 100 for performing trajectory planning for an object in accordance with aspects of the present disclosure. In certain aspects, the system 100 may utilize an ST scene 102, a model 104, a first trajectory 106, a model 108, and another trajectory 110.

In some aspects, an ST scene 102 represents a displacement of one or more agents over time with respect to a reference point corresponding to a current position of an object, as well as a target location of the object, operating within an environment. In certain aspects, a reference point may refer to the location of the object (e.g., a vehicle) at a given moment in time and may serve as the origin or starting point for representing the displacement of other agents in the ST scene 102. For example, if the object is an autonomous vehicle, the reference point would be the vehicle's current position on the road. In some aspects, a target location may refer to a desired endpoint or destination that the object aims to reach, such as, but not limited to, a specific point on the map, an area, a street address, a parking spot, or a charging station. In some aspects, the environment in which the object operates can be complex and may include, among other things, urban streets, highways, rural roads, off-road terrain, parking lots, or indoor spaces such as warehouses or factories.

In certain aspects, the ST scene 102 can provide a compact representation of a scene around the object, encoding spatial and temporal information in a format for input into one or more machine learning models. In some aspects, the scene refers to the immediate surroundings of the object, including the static and dynamic elements that the object may perceive, understand, and navigate through, and may be a subset of the larger environment. In some aspects, the scene may include various elements that the object is to perceive, understand, and navigate through, such as static obstacles (e.g., buildings, trees, road signs), dynamic agents (e.g., other vehicles, pedestrians, cyclists), and/or road features (e.g., lane markings, traffic lights, speed limits). In some examples, to gather information about the environment, the object may be equipped with one or more sensors that collect data from its surroundings. Such sensor(s) can include, but are not limited to, one or more of a camera, light detection and ranging (LIDAR) sensor, radar, ultrasonic sensor, and/or global positioning system (GPS). Alternatively, or in addition, information about the environment may be obtained from another object, or source.

In certain aspects, the ST scene 102 can communicate the dynamic nature of the environment by representing movement of agents and the object over a specified time horizon. That is, in some aspects, the ST scene 102 can discretize a continuous space and time into a grid-like structure, where a cell in the grid-like structure may correspond to a specific location (station) and time instant. In the real world, space and time are continuous domains. Objects move and interact in a seamless manner, and their positions and velocities can take on any value within a continuous range. However, when it comes to representing the environment for trajectory planning, the continuous domains (e.g., space and time) can be discretized into a more manageable form in size and/or computational complexity.

In some examples, the ST scene 102 can represent the continuous space and time in a grid-like structure. The spatial dimension, which can represent the physical environment, can be discretized into a set of locations or stations. These stations can be thought of as points or regions in space that are relevant for trajectory planning. The granularity of the spatial discretization may depend on the specific requirements of a trajectory planning system and a desired level of precision. For example, in an urban driving scenario, the stations in the ST scene 102 may correspond to positions on the road, such as the center of each lane, the boundaries of intersections, or key points along the path. The spacing between the stations can determine the resolution of the spatial discretization (e.g., size of the cell). A finer granularity (i.e., smaller spacing between stations) can provide a more detailed representation of the environment but may also increase a computational complexity associated with processing the ST scene 102.

Similarly, the time dimension can be discretized into a set of time instants or steps. The continuous flow of time can be divided into discrete intervals, where each interval can represent a specific moment or duration. The granularity of the temporal discretization can determine the time step size, which may be the duration between consecutive time instants. The choice of time step size can depend on various factors, such as, but not limited to, the dynamics of the object, the speed of the agents in the environment, and a required planning horizon. In certain aspects, a smaller time step size may allow for more precise trajectory planning and may better capture the dynamic nature of the environment. However, increasing the number of time steps required to cover a given planning horizon may also increase a computational complexity associated with processing the ST scene 102.

By discretizing the space and time dimensions, the ST scene 102 can comprise a grid-like structure where each cell can represent a unique combination of a station and a time instant. In some aspects, each cell in the ST scene 102 includes relevant information about the environment at that specific location and time. This information may include the occupancy status (i.e., whether the cell is occupied by an obstacle or agent), the velocity of the agents, and other attributes that are relevant for trajectory planning. This structured representation can be used by trajectory planning models to learn and infer spatiotemporal relationships and make informed decisions. In some aspects, the ST scene 102 represents not only the ego and agent trajectories but also captures additional features of the environment. These features may include static objects, occlusions, and/or map features such as speed limit changes, making the ST scene 102 a more comprehensive and generic representation of the surrounding context.

In some aspects, the ST scene 102 can be provided as input to model 104. In some examples, the model 104 may be referred to as a local planner model, where a local planner model can generate collision-free paths that follow a global plan while adhering to vehicle dynamics constraints and avoiding obstacles. In some aspects, the local planner can operate on a reduced, or limited, time horizon and may consider the immediate surroundings of the object.

In certain aspects, the model 104 may process the ST scene 102 and output a first trajectory 106 for the object to follow to reach a target location. In some aspects, the model 104 may be trained to extract relevant features from the ST scene 102, such as the positions and velocities of agents, road boundaries, and/or obstacles. In certain aspects, the model 104 may use such information to generate a trajectory that satisfies one or more constraints (e.g., is feasible, safe, and efficient), where the trajectory indicates a sequence of states or actions for the object to navigate through the dynamic environment.

In certain aspects, the sequence of states or actions can represent the specific steps or decisions that the object should take at each time step along the trajectory. These states or actions can provide a detailed plan for how the object should move and behave in order to reach its target location while satisfying the given constraints. Some examples of the information contained in the sequence of states or actions include, but are not limited to position, velocities, accelerations, headings, steering angels, and/or actions. In some aspects, the trajectory may specify the desired positions of the object at each time step, indicating the precise locations it should aim to reach as it navigates through the environment. In some aspects, the trajectory may include the target velocities for the object at different points along the path, dictating how fast it should be moving at each time step. In some aspects, the trajectory may provide the accelerations or decelerations that the object should apply to achieve the desired velocities and positions. In some aspects, the trajectory may specify the heading or orientation of the object at each time step, indicating the direction it should be facing as it moves along the path. In some aspects, for objects with steering capabilities, such as vehicles, the trajectory may include the steering angles required to follow the desired path and navigate through turns or lane changes. In some aspects, the trajectory may be represented as a sequence of high-level actions, such as “accelerate,” “brake,” “turn left,” or “change lane,” which provide a more abstract representation of the object’s behavior. The specific representation of the states or actions in the trajectory can depend on the requirements of the object’s motion planning and control systems.

In some aspects, the trajectory can provide sufficient information for one or more systems to execute one or more planned paths and navigate through an environment safely and efficiently. In certain aspects, by indicating the sequence of states or actions, the trajectory can act as a roadmap for the object to follow, guiding it through the dynamic environment towards its target location while adhering to the specified constraints and optimizing relevant criteria such as safety, efficiency, and ride comfort.

In certain aspects, the architecture of the model 104 can vary depending on the requirements and complexity of the trajectory planning task. The model 104 may include one or more convolutional neural networks (CNNs) that process spatial information represented by the ST scene 102, and one or more recurrent neural networks (RNNs) or temporal convolutional networks (TCNs) to identify temporal dependencies. The model 104 can be trained on a dataset of driving scenarios and the corresponding optimal trajectories (e.g., ground truth) to learn the mapping from ST scenes to trajectory.

In some aspects, the trajectory 106 represents a sequence of states or actions that the object could take over time to navigate from its current position to a desired destination. In some aspects, the trajectory 106 can be a continuous path that specifies the object’s position, velocity, and/or other relevant parameters at each time step. The trajectory 106 can take into account the dynamic environment represented in the ST scene 102, including the motion of agents and/or one or more static obstacles.

In some aspects, the trajectory 106 can be generated by the model 104, where the model 104 may generate the trajectory 106 based on optimizing certain criteria, such as minimizing the travel time, maximizing safety, or ensuring smooth and comfortable motion. In certain aspects, the model 104 can consider the object’s dynamics, such as the object’s acceleration and turning capabilities, to generate a trajectory 106 that is physically feasible and within one or more constraints imposed by the environment.

In some aspects, the trajectory 106 may be represented as a sequence of waypoints or control commands that the object’s motion planning and control systems can execute. For example, each waypoint may specify a desired state of the object at a particular time instant, such as its position, velocity, and/or heading. The spacing between the waypoints can determine the granularity of the trajectory 106 and the level of control over the object’s motion.

In some aspects, the generated trajectory 106 can then be provided as input to a model 108. In some examples, model 108 may be referred to as a global search model. In certain aspects, a global search model may be responsible for exploring a larger search space and considering long-term goals and constraints. The global search model can consider a broader view of the environment and can find a path (e.g., optimal path) from an object’s current position to a target location. In some aspects, the model 108 receives the trajectory 106 as a possible initial solution or query. In some aspects, a query serves as an interaction between the global search model and the local planner, where the local planner provides an initial trajectory that the global search model can then process based on additional information and objectives. For example, the global search model may iteratively refine and update the trajectory 106 based on additional information and objectives, may select the trajectory 106 as a trajectory to be followed, or may select a different trajectory from a different model (e.g., local planner), for subsequent processing and use. For example, the global search model can consider factors such as, but not limited to, an overall route, traffic conditions, road network topology, and/or high-level navigation goals. In certain aspects. the global search model can explore multiple potential trajectories and evaluate them based on various criteria, such as minimizing the total travel time, avoiding congested areas, or maximizing the safety of the route.

In some aspects, the global search model may employ various search algorithms or optimization techniques to explore a trajectory space in an efficient manner. For example, the global search model can use graph search algorithms like A* or sampling-based methods like rapidly exploring random trees (RRT) to generate and evaluate candidate trajectories. In certain aspects, the global search model may incorporate domain-specific heuristics or machine learning techniques to guide the search process and identify regions of interest in the search space.

In some aspects, during a search process, the model 108 can iteratively generate and evaluate multiple trajectories, gradually improving one or more of the multiple trajectories based on defined objectives and constraints, where such defined objectives and constraints can refer to a set of criteria that guide the model 108 in evaluating and improving the trajectories it generates. In certain aspects, the objectives and constraints can be designed to align with the overall goals and requirements of a trajectory planning system, taking into account factors such as safety, efficiency, feasibility, and/or compliance with traffic rules. Some common objectives that the global search model may consider include, but are not limited to: minimizing travel time, maximizing safety, ensuring smooth and comfortable motion, and/or optimizing energy efficiency.

In addition to these objectives, the model 108 can operate within a set of constraints that define the boundaries and limitations of a trajectory planning problem. In certain aspects, these constraints may include, but are not limited to, vehicle dynamics, road boundaries and lane constraints, traffic rules and regulations, and/or obstacle avoidance. In some examples, the model 108 can modify the initial trajectory 106 by adjusting waypoint(s), adding or removing intermediate goal(s), or optimizing the trajectory parameter(s). In some examples, the model 108 aims to find the best overall path that satisfies the long-term goals while considering the dynamic nature of the environment.

In some aspects, after the model 108 performs a search process and identifies a trajectory for an object to follow, the model 108 outputs the identified trajectory as another trajectory 110. In some aspects, the trajectory 110 incorporates one or more refinements made by the model 108. In examples, the trajectory 110 can take into account the dynamic environment, the object’s constraints, and/or the long-term objectives of the object, providing a more comprehensive plan for navigating a scene.

In some aspects, the trajectory 110 can be represented in a similar format to trajectory 106, indicating one or more desired states of the object at different time steps. However, the trajectory 110 may have a longer time horizon and may include additional information, such as intermediate waypoints or high-level navigation instructions. In certain aspects, the trajectory 110 can be used by the object’s motion planning and control systems to execute the planned path and navigate through the environment.

### Example Scenario and Corresponding ST Scene

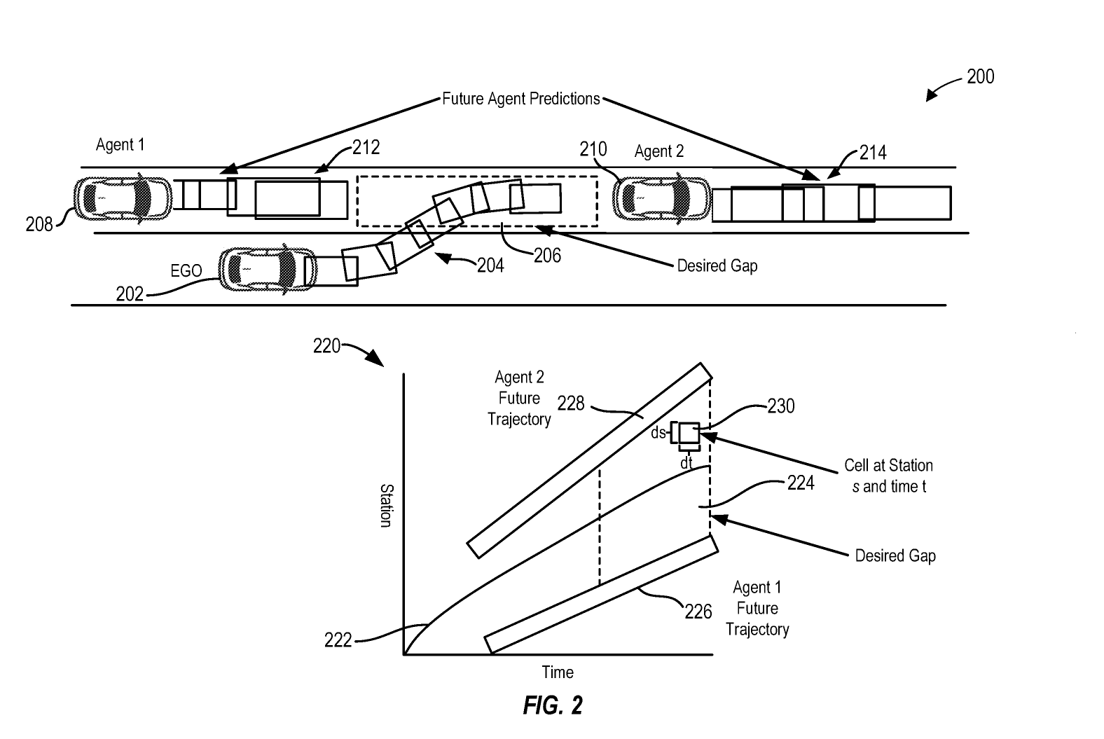

FIG. 2 depicts an example scenario 200 and a corresponding ST scene 220 in accordance with aspects of the present disclosure. In some aspects, the example scenario 200 depicts a driving situation involving an ego vehicle 202 and two agents 208 and 210, while the ST scene 220 represents a compact and efficient encoding of the spatial and temporal information of the example scenario 200. In aspects, the ego vehicle 202 refers to the vehicle or object for which a trajectory is being determined. Sensors that perceive the environment could be mounted on the ego vehicle 202 itself, or they could be external, such as cameras or other sensors placed along the road or on other vehicles.

In the example scenario 200 depicted in FIG. 2, an object, such as the ego vehicle 202, is shown with a predicted trajectory or path 204 corresponding to a lane change or lane merge operation. The example scenario 200 represents a specific driving situation or context in which the ego vehicle 202 operates and encapsulates the relevant elements and interactions within the environment at a given point in time. In certain aspects, the predicted path 204 represents the anticipated movement of the ego vehicle 202 over a certain time horizon, taking into account its current state and the surrounding environment. That is, in some aspects, the predicted path 204 can be based on the ego vehicle’s 202 current state, such as its position, velocity, and heading, as well as its intended destination or goal. The predicted path 204 can take into account the ego vehicle’s 202 dynamics, constraints, and the environment’s layout, such as road boundaries and obstacles.

In some aspects, the scenario 200 can include a desired gap 206, which can represent a safe and feasible space that the ego vehicle 202 aims to navigate into. In some examples, the desired gap 206 represents a region in the environment that is considered optimal for the ego vehicle’s 202 trajectory, taking into account factors such as safety, efficiency, and compliance with traffic rules. The desired gap 206 can be determined based on the ego vehicle’s 202 objectives, such as maintaining a safe distance from other agents and ensuring smooth and efficient motion.

Two agents, a first agent 208 and a second agent 210, are depicted in the example scenario 200. These agents represent other vehicles, objects, or obstacles, in the environment that the ego vehicle 202 is to consider when planning a trajectory. The future predictions for the first agent 208 are also depicted in the scenario 200 as trajectories 212. These future predictions represent the anticipated movement of the first agent 208 over a certain time horizon, based on its current state, past behavior, and other contextual information. Similarly, the future predictions for the second agent 210 are shown as trajectory 214.

In some aspects, the future predictions (e.g., trajectories 212 and trajectories 214) may be generated by a separate prediction module or model that analyzes the historical data and patterns of the agents’ 208 and 210 motion. Such predictions can take into account factors such as the agents’ velocities, accelerations, heading angles, and/or interactions with the environment and/or other agents.

In certain aspects, the ST scene 220 can provide a compact representation of the example scenario 200, capturing the spatial and temporal relationships between the ego vehicle 202 and the other agents. In some aspects, the ST scene 220 can be organized as a grid of cells, where each cell corresponds to a specific location (station) and time. As depicted in the ST scene 220, the predicted path or trajectory for the ego vehicle 202 can be represented as trajectory 222. The trajectory 222 is similar to the predicted path 204 in the example scenario 200 and can represent the anticipated movement of the ego vehicle 202 over time. In some examples, the desired gap 206 from the example scenario 200 can be encoded in the ST scene 220 as gap 224. The gap 224 represents the safe and feasible space that the ego vehicle 202 aims to navigate through, considering the spatial and temporal constraints of the environment.

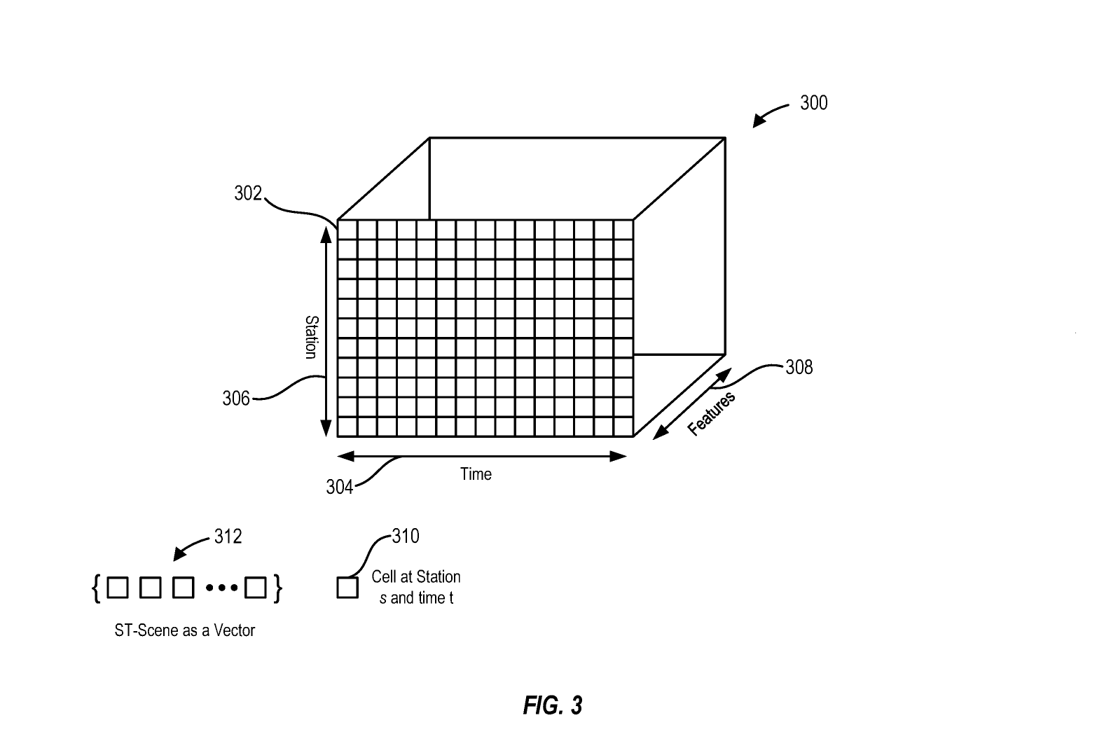

The trajectory 212 of the first agent 208 is represented in the ST scene 220 as trajectory 226. This trajectory 226 is similar to the trajectory 212 in the example scenario 200 and can capture the anticipated movement of the first agent 208 over time. Likewise, the trajectory 214 of the second agent 210 can be encoded as trajectory 228 in the ST scene 220. As will be described in FIG. 3, and in some aspects, each cell (e.g., 230) in the ST scene 220, can represent a specific location (station) and time. The cell 230 can include information about the occupancy and state of that particular location at that specific time instant. Such information can include the presence of agents, their predicted trajectories, and other relevant features.

As described above, the ST scene 220 can provide a structured representation of a dynamic environment, enabling trajectory planning models to learn and infer spatial and temporal relationships between ego vehicles (e.g., ego vehicle 202) and other agents (e.g., agents 208 and 210). By encoding the scenario (e.g., scenario 200) information in a discretized grid of cells, the ST scene 220 can be used to generate contextually aware trajectories for the ego vehicle 202.

### Example ST Scene

FIG. 3 depicts an example ST scene 300 and its corresponding representation as a vector representation 312 in accordance with aspects of the present disclosure. In some aspects, the ST scene 300 can be organized as a three-dimensional grid, where each cell 302 corresponds to a specific location (station) and time instant. The grid can be defined by three axes: the time axis 304, the station axis 306, and the features axis 308. In some aspects, the time axis 304 represents a temporal dimension of the ST scene 300. The time axis 304 can represent the evolution of the scenario over a certain time horizon, discretized into fixed time steps. In some examples, each point along the time axis 304 may correspond to a specific time instant, such as t₀, t₁, t₂, etc. The granularity of the time steps can be adjusted based on requirements of a trajectory planning system and dynamics of the environment.

In some aspects, the station axis 306 represents a spatial dimension of the ST scene 300. The station axis 306 can represent different locations (or stations) within the scenario, relative to the ego vehicle’s 202 current position. In some examples, each point along the station axis 306 may correspond to a specific station or location, such as s₀, s₁, s₂, etc. As described earlier, the stations can be defined based on a discretization of the environment, such as a grid or a set of key points. In some examples, the features axis 308 can represent different features or attributes associated with each cell 302 in the ST scene 300. In examples, each point along the features axis 308 may correspond to a specific feature, such as occupancy, velocity, acceleration, agent type, road boundaries, traffic rules, etc. In some aspects, the features can capture relevant information about the state of the environment and/or the agents at each cell.

In some aspects, an occlusion and/or occlusion type may be a feature captured in each cell of the ST scene 300. While the presence of agents is typically represented, the ST scene 300 can also incorporate information about various environmental occlusions. These occlusions may include objects or structures that obstruct the view of the ego vehicle or other agents, providing a more comprehensive understanding of the scene’s visibility constraints.

In some aspects, the example cell 310 at station s and time t represents a specific instance within the ST scene 300. The example cell 310 may correspond to a particular location and time instant, capturing the state of the environment at that specific point. In some aspects, the cell 310 may include the feature values associated with that station and time, providing a snapshot of the scenario at that moment. In some examples, each cell in the ST scene 300, such as the example cell 310, encapsulates the relevant information about the environment and agents at a specific location and time. In some aspects, the cells can contain binary values, indicating the presence or absence of certain features, or continuous values, representing a magnitude or intensity of the features. The content of each cell can depend on the selected features and the available data, for example, from sensors and perception systems.

In some examples, a vector representation 312 can represent the ST scene 300. In this representation, the ST scene 300 can be flattened into a one-dimensional array, where each element corresponds to a cell in the grid. In some aspects, the vector representation 312 can provide a compact and efficient format for storing and processing the ST scene data. In some aspects, in the vector representation 312, the cells can be ordered based on a specific traversal pattern, such as row-major or column-major order. The ordering can determine how the cells are arranged in the vector and can affect the way the data is accessed and processed by a trajectory planning models.

### Example System for Converting a Scene Representation into an ST Scene

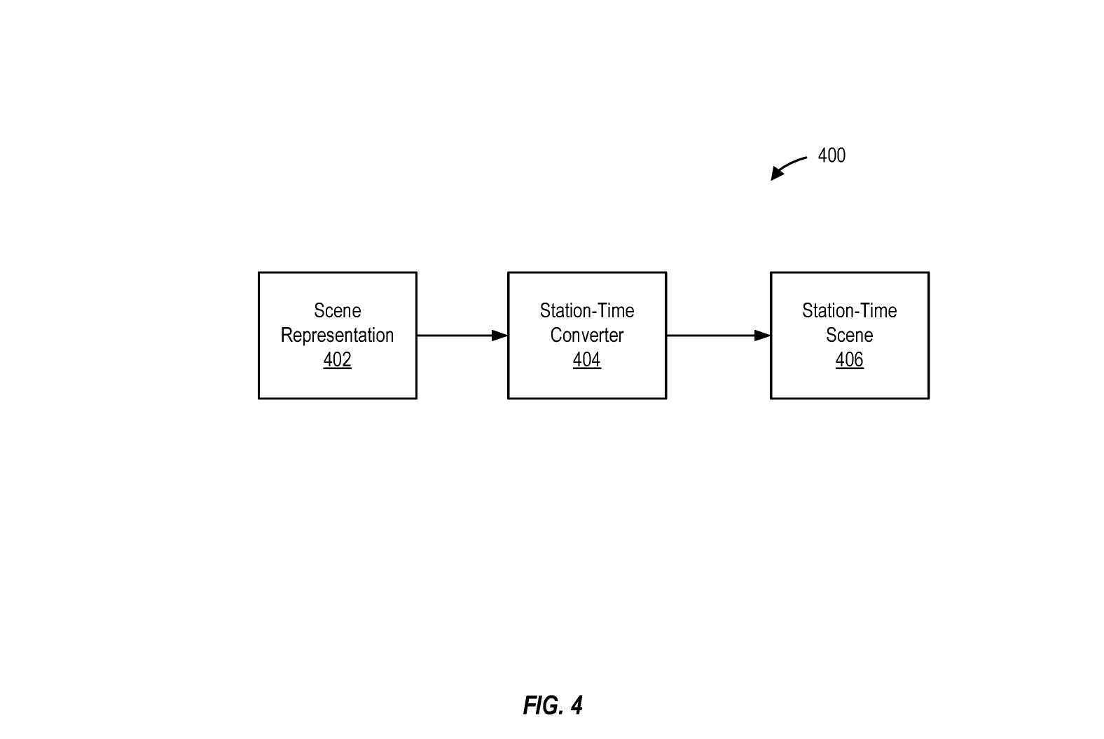

FIG. 4 depicts a system 400 for converting a scene representation into an ST scene representation in accordance with aspects of the present disclosure. In certain aspects, the system 400 receives a raw or initial scene representation 402 as input and processes it through a station-time converter 404 to generate an ST scene 406. As previously described, the ST scene 406 can provide a compact and structured representation of a driving scenario, capturing spatial and temporal information in a format that can be used for trajectory planning models.

In some aspects, the scene representation 402 represents the raw or initial description of a driving scenario, and may include information about the environment, agents, and their states at a given point in time. The scene representation 402 can take various forms, such as, but not limited to, sensor data, perception outputs, or high-level abstractions of the scenario. In some aspects, the scene representation 402 may include data from multiple sensors, such as cameras, lidar, radar, GPS, ultrasonic sensors, and inertial measurement units (IMUs). In some aspects, these sensors can provide raw measurements of the environment, including the positions and velocities of agents, road boundaries, traffic signs, lane markings, and other relevant features. In some examples, sensor data from one or more sensors may include, but is not limited to, one or more images, one or more point clouds, one or more coordinates, one or more velocities, or one or more proximity measurements. In examples, the scene representation 402 may also include processed data from perception modules, such as object detection, tracking, classification results, semantic segmentation, lane detection, pedestrian detection, vehicle detection, obstacle detection, and free space detection.

In examples, the scene representation 402 includes information describing a driving scenario but may not be in a format that is directly suitable for trajectory planning models. For example, the scene representation 402 may have a high-dimensional and unstructured nature, making it challenging for models to learn and infer spatial and temporal relationships between agents and the environment.

In some aspects, the station-time converter 404 can transform the scene representation 402 into the ST scene 406. In certain aspects, the station-time converter 404 can process the raw or initial scene data and organize it into a structured grid format, where each cell corresponds to a specific location (station) and time instant. In certain aspects, the station-time converter 404 can discretize spatial and temporal dimensions of the scene representation 402 based on a desired resolution and granularity. The station-time convert 404 can map the continuous space and time into discrete stations and time steps, creating a grid-like structure, for example the ST scene 300 of FIG. 3. For each cell in the ST scene 406, the station-time converter 404 can extract and aggregate relevant features from the scene representation 402. That is, the station-time converter can collect information about the occupancy, velocity, acceleration, agent type, road boundaries, traffic rules, and/or other attributes associated with one or more station and one or more time instant. In some aspects, the station-time converter 404 may apply various preprocessing techniques, such as normalization, scaling, or encoding, to provide the features in a suitable format for the trajectory planning models.

In some aspects, the station-time converter 404 can handle the alignment and synchronization of data from multiple sensors or perception modules. For example, the station-time converter 404 can manage information received from different sources and process the information to properly merge and integrate the information into the ST scene 406. In some aspects, the station-time converter 404 may apply techniques such as sensor fusion, temporal interpolation, or spatial calibration to create a consistent and coherent representation of the driving scenario.

The output of the station-time converter may be the ST scene 406 that captures spatial and temporal information in a format that can be used by trajectory planning models to process and infer relationships and patterns in data. As previously described, the ST scene 406 can be organized as a three-dimensional grid, with axes representing time, station, and features. In some examples, one or more cells in the grid can correspond to a specific location and time instant, containing the relevant feature values associated with that point in the scenario. In some aspects, the ST scene 406 can provide a unified and consistent representation of the environment and agents, enabling the trajectory planning models to consider the spatial and temporal relationships when generating trajectories.

### Example Trajectory Planning System

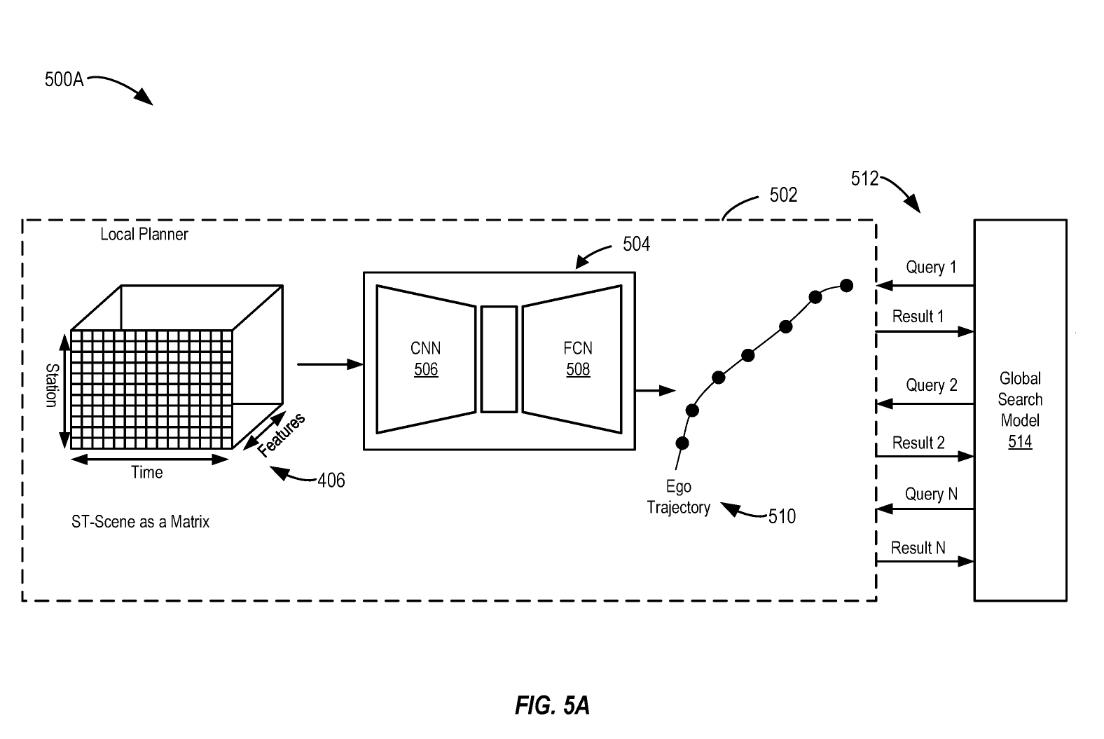

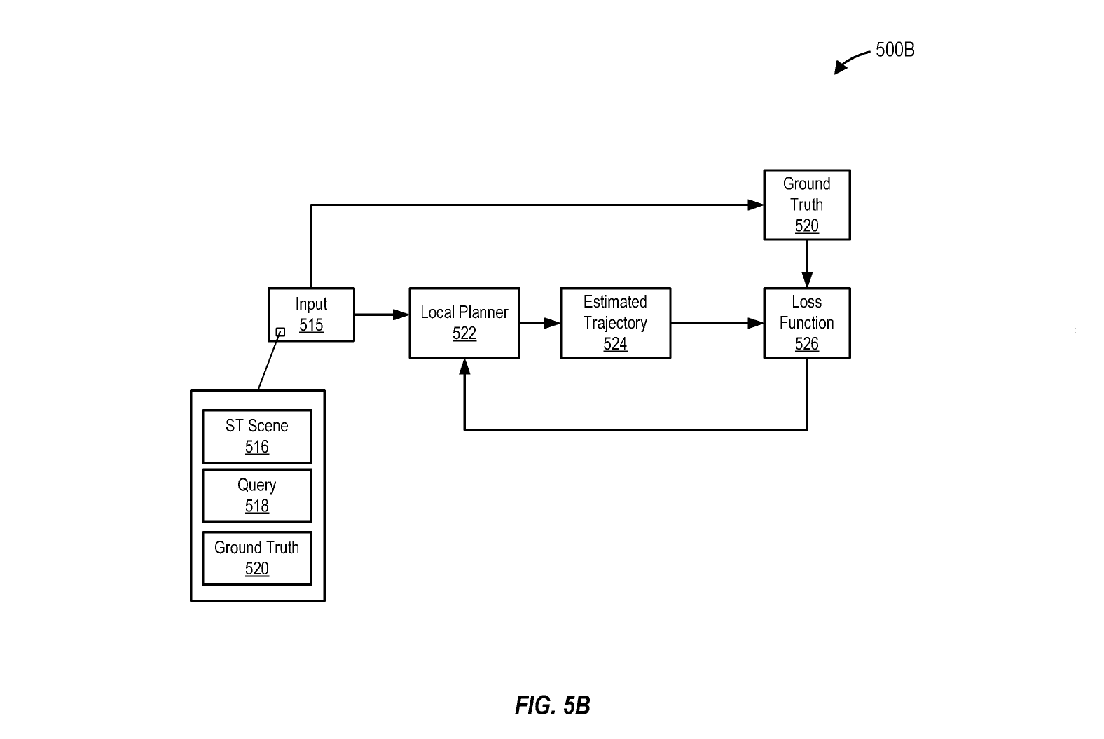

FIG. 5A depicts details of a local planner 502 using a ST scene 406 in accordance with aspects of the present disclosure. As previously described, the local planner 502 can be a component of a trajectory planning system 500A that generates short-term, preferably collision-free trajectories for an ego vehicle based on the information provided in the ST scene 406. In certain aspects, the local planner 502 utilizes a machine learning model 504 to process the ST scene 406 and generate an ego trajectory 510 in response to a given query 512, and provides the ego trajectory 510 to the global search model 514 as a result.

As previously described, the local planner 502 may receive information concerning the local surroundings of the ego vehicle (e.g., ego vehicle 202 of FIG. 2) and generate paths that allow the ego vehicle to navigate an environment. In some aspects, the local planner 502 can operated on a limited, or reduced, time horizon and may consider local context captured in the ST scene 406. The local planner 502 can take the ST scene 406 as input, where the ST scene 406 can provide spatial and temporal information of the environment, including the positions and predicted trajectories of other agents, road boundaries, and relevant features. By leveraging the ST scene 406, the local planner 502 can infer dynamic relationships between the ego vehicle and its surroundings.

In some aspects, the local planner 502 includes the machine learning model 504. In certain aspects, the machine learning model 504 can process the ST scene 406 and generate an ego trajectory 510 based on a query received from the global search model 514. In some aspects, a query may refer to a request or an input from the global search model 514 to the local planner 502, asking for a trajectory that satisfies certain conditions or constraints. In some aspects, the query can include information such as, but not limited to, the desired start and end points of the trajectory, the time horizon, or any other relevant parameters that the global search model 514 indicates that the local planner 502 is to consider when generating the ego trajectory 510. For example, the global search model 514 might send a query to the local planner 502 asking for a trajectory that starts from the ego vehicle's current position, reaches a specific goal point within a certain time limit, and avoids any obstacles or traffic violations along the way. The machine learning model 504 can be trained to extract relevant features from the ST scene 406 and make informed decisions about the ego vehicle’s path based on inferred relationships and patterns in the extracted relevant features. The machine learning model 504 can be implemented using various architectures and techniques. In some aspects, the machine learning model 504 may include a combination of at least one convolutional neural network (CNN) model 506 and one or more fully connected networks 508.

In some aspects, the CNN model 506 may include multiple convolutional layers that learn hierarchical representations of the ST scene 406. In some aspects, the early layers of the CNN model 506 may be trained to detect low-level features, such as the presence of obstacles or the positions of agents, while the later layers of the CNN model 506 may be trained to capture higher-level concepts and relationships. In some aspects, the CNN model 506 can include pooling layers to downsample feature maps and reduce the computational complexity of the CNN model 506. In addition to the CNN model 506, the machine learning model 504 may include a fully connected network 508. In some aspects, the fully connected network 508 can receive the features output from the CNN model 506 and performs further processing to generate the ego trajectory 510. In certain aspects, the fully connected network 508 may include one or more layers of interconnected neurons that learn to map the extracted features from the CNN model 506 to a desired output, such as a trajectory. In some aspects, the one or more fully connected network 508 can capture complex relationships and dependencies between the features and the ego trajectory. The fully connected network 508 may include activation functions, such as ReLU or sigmoid, to introduce non-linearity and enable the learning of more sophisticated patterns.

In some aspects, the output of the machine learning model 504 may be an ego trajectory 510. The ego trajectory 510 may represent a planned path for the ego vehicle to follow in the near future. In certain aspects, the ego trajectory 510 is a sequence of states or actions that define the desired positions, velocities, and/or orientations of the ego vehicle over time. In some examples, the ego trajectory 510 can be generated based on the input ST scene 406 and the query 512 received from the global search model 514. In certain aspects, the query 512 includes a desired behavior or goal for the ego vehicle, such as maintaining a certain speed, reaching a target location, or executing a specific maneuver. The machine learning model 504 can receive the query 512, and utilize the query 512 when generating the ego trajectory 510, ensuring that the ego trajectory 510 corresponds to one or more specified objectives.

In certain aspects, the example query 512 and results illustrate the interaction between the local planner 502 and the global search model 514. In certain aspects, the global search model 514 may be responsible for exploring a larger search space and considering long-term goals and constraints than the local planner 502. In some aspects, the global search model 514 can provide high-level guidance to the local planner 502 by generating queries or objectives that the local planner 502 should aim to satisfy.

In some aspects, the global search model 514 may iterate over multiple queries and evaluate the corresponding results generated by one or more local planners 502. In some aspects, the use of multiple local planners 502 can help to explore a wider range of potential trajectories and improve the overall performance of a trajectory planning system. For example, each local planner 502 may specialize in generating trajectories for specific scenarios or may use different algorithms or machine learning models to generate trajectories. In some aspects, one local planner 502 may focus on generating trajectories for highway driving, while another local planner 502 may specialize in urban environments with dense traffic and pedestrians. In some aspects, the global search model 514 can send queries to these multiple local planners and compare the resulting trajectories to determine which one is more suitable for the current situation, given the scene and environment. In certain aspects, the techniques herein may allow the system to leverage the strengths of different local planners and adapt to various driving conditions. In certain aspects, the global search model 514 can evaluate the quality and feasibility of the ego trajectories received from the local planner 502 based on various criteria, such as safety, efficiency, and progress towards an ultimate goal. In some examples, the global search model 514 guides the local planner 502 towards more promising regions of a search space and helps in finding a trajectory for the ego vehicle.

As another example, the global search model 514 may explore and evaluate one or more potential ego trajectories. In some aspects, the global search model 514 may consider a vector of ego decisions, where each decision represents a possible action or maneuver by the ego. For each ego decision, the machine learning model 504 can generate a corresponding ego trajectory 510. The global search model 514 can then evaluate the generated trajectories and selects one based on predefined criteria

In one or more aspects, the interaction between the local planner 502 and the global search model 514 can be iterative and bidirectional. For example, the local planner 502 can generate an ego trajectory based on the query received from the global search model 514, while the global search model 514 can use one or more results and feedback from the local planner 502 to refine its search strategy and generate new queries. This collaborative process allows for an efficient exploration of a trajectory space and the identification of an optimal path for the ego vehicle.

### Example Training Process for a Machine Learning Model that Generates a Trajectory

FIG. 5B depicts an example training process 500B for a machine learning model used to generate an estimated trajectory for an object in accordance with aspects of the present disclosure. In some aspects, the training process 500B can include various components such as input data 515, an ST scene 516, a query 518, ground truth data 520, a local planner model 522, an estimated trajectory 524, and a loss function 526. In some aspects, the ST scene 516 is an input to the local planner model 522. The ST scene 516 can represent the spatio-temporal relationships between the object and the other agents in the scene, encoding the relevant information in a compact and structured format that can be efficiently processed by the local planner model 522.

In some examples, the ST scene 516 can be constructed based on the environmental data and an object’s state, capturing the features used for trajectory planning. The input data 515 may include a query 518, mimicking a query received from a global search model, and a ground truth data 520. In some aspects, the query 518 represents a specific task or goal for the object, such as reaching a target location while avoiding collisions with other agents. The query 518 is used as an input to the local planner model 522, along with the ST scene 516, to generate the estimated trajectory 524. The ground truth data 520 represents the optimal or expert trajectory for the object given the ST scene 516 and the query 518. In some examples, the ground truth data 520 is obtained from human demonstrations or from running a computationally expensive motion planning algorithm offline. In some aspects, the ground truth data 520 serves as a reference for training the local planner model 522 and for evaluating the quality of the estimated trajectory 524.

The local planner model 522 can be a machine learning model, such as a neural network, that takes the ST scene 516 and the query 518 as inputs and generates an estimated trajectory 524 as output. During training, the local planner model 522 may iteratively adjust its parameters to minimize the difference between the estimated trajectory 524 and the ground truth data 520, which may be quantified by the loss function 526. In some aspects, the loss function 526 may be a component utilized in training the local planner model 522, as the loss function 526 can quantify differences between the estimated trajectory generated by the local planner 522 and the ground truth trajectory (e.g., 520). In certain aspects, the loss function 526 can be designed to consider various aspects of a trajectory, such as, but not limited to, the position, velocity, acceleration, and heading of a vehicle at each time step. For example, the loss function 526 may calculate the mean squared error (MSE) between the estimated and ground truth positions, velocities, and accelerations. To adjust the parameters of the local planner model, an optimization algorithm, such as stochastic gradient descent (SGD) or Adam, can be used. In certain aspects, the optimization algorithm can compute gradients of the loss function 526 with respect to the model's parameters and updates these parameters iteratively to minimize the loss. This process can be repeated for multiple epochs until the local planner 522 converges to a state where it generates trajectories that more closely resemble the ground truth data. The estimated trajectory 524 represents the output of the local planner model 522 for a given input ST scene 516 and query 518. The quality of the estimated trajectory 524 may be evaluated by comparing it to the ground truth data 520 using the loss function 526. By minimizing the loss function 526, the local planner model 522 can learn to generate trajectories that closely match the ground truth data 520 and satisfy the given query 518.

### Example Artificial Intelligence System for Generating a Trajectory

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as an autonomous vehicle navigation system.

ML models may be deployed in one or more devices (e.g., autonomous vehicles, devices, or other intelligent agents) to support various aspects of trajectory planning and decision-making. For example, an ML model may be trained to identify patterns and relationships in data corresponding to the environment, agent behaviors, or the like. An ML model may improve operations relating to one or more aspects, such as perception, prediction, planning, and control associated with autonomous systems.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

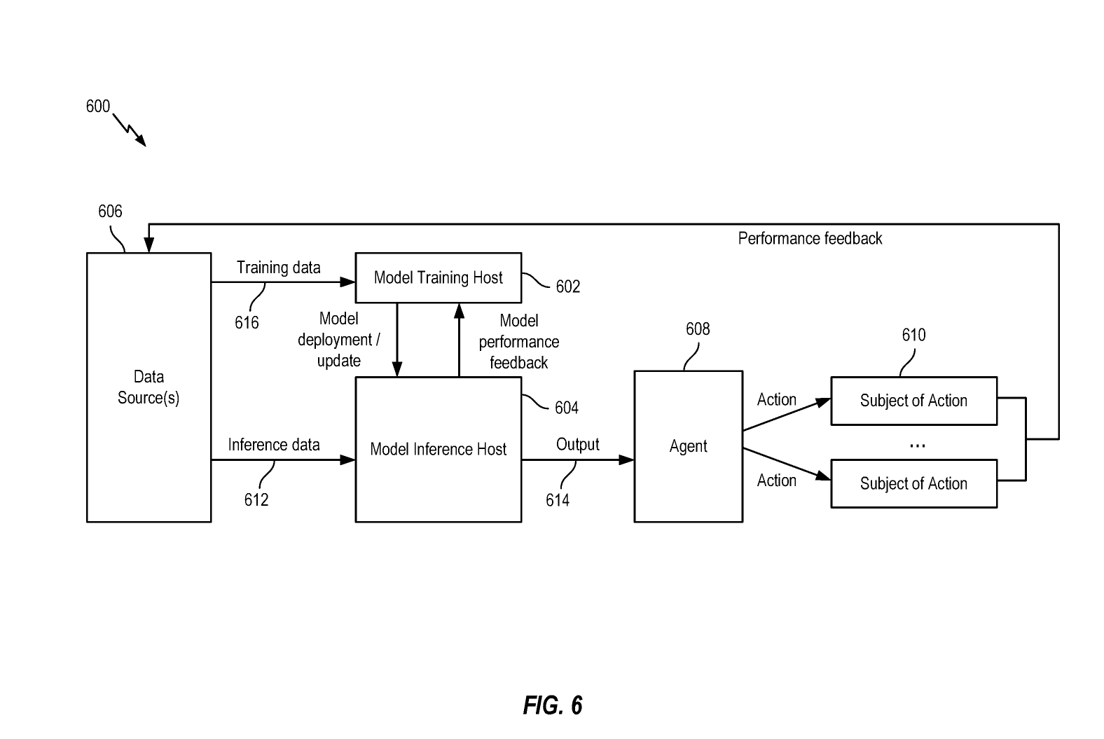

FIG. 6 is a diagram illustrating an example AI architecture 600 that may be used to implement the machine learning models and trajectory planning techniques discussed herein. As illustrated, the architecture 600 includes multiple logical entities, such as a model training host 602 for training the machine learning model with the ST scene representation and query-conditioned approach, a model inference host 604 for running inference using the trained model, data source(s) 606 providing training and inference data, and an agent 608 that utilizes the model’s output. This AI architecture could be used to enable example trajectory planning techniques in various autonomous systems.

The model inference host 604, in the architecture 600, is configured to run an ML model based on inference data 612 provided by data source(s) 606. The model inference host 604 may produce an output 614 (e.g., a predicted trajectory) based on the inference data 612, that is then provided as input to the agent 608.

The agent 608 may be an element or entity that utilizes the output of the machine learning model hosted by the model inference host 604. The agent 608 could be an autonomous vehicle, a robot, a device, or any other intelligent system that leverages the trajectories produced by the model for navigation and decision-making.

For example, if the output 614 from the model inference host 604 is a planned trajectory obtained through the query-conditioned approach, the agent 608 may be an autonomous vehicle that uses the trajectory for navigating in its environment. As another example, if the output 614 is a set of candidate trajectories produced by a model trained with the ST scene representation, the agent 608 could be a robot, or other device, that selects the best trajectory based on its current goals and executes it.

After receiving the output 614 from the model inference host 604, the agent 608 may determine how to utilize it. For instance, if the agent 608 is an autonomous vehicle and the output is a planned trajectory, it may use the trajectory to control its actuators and navigate safely. If the agent 608 decides to use the output 614, it may apply it to the subject of the action 610, which represents the environment or system being acted upon. In the autonomous vehicle example, the subject of action 610 would be the vehicle’s motion control system. In some cases, the agent 608 and subject of action 610 may be tightly integrated.

The data sources 606 may be configured to collect data used as training data 616 for the model training host 602 to train the trajectory planning models. The data sources 606 may also provide inference data 612 to the model inference host 604. This data could come from various entities and may include the subject of action 610. For example, for training a trajectory planning model, the data sources 606 may collect sensor data from an autonomous vehicle, along with corresponding ground truth trajectories. The model training host 602 can then monitor the model’s performance on this data to determine if retraining or fine-tuning with the ST scene representation and query-conditioned approach is necessary to improve accuracy. In some cases, the agent 608 and the subject of action 610 are the same entity.

The data sources 606 may be configured for collecting data that is used as training data 616 for training the machine learning model with the ST scene representation and query-conditioned approach. The data sources 606 may also provide inference data 612 (also referred to as input data) for feeding the trained model during inference. In particular, the data sources 606 may collect data relevant to the trajectory planning task at hand, such as sensor data from an autonomous vehicle, robot, or other device. This data may come from various sources, including the subject of action 610, which represents the environment or system being acted upon by the model. The collected data is provided to the model training host 602 for training and fine-tuning the trajectory planning model. For example, after the subject of action 610 (e.g., an autonomous vehicle) executes a planned trajectory, the resulting sensor data and feedback may be compared to the expected outcome to evaluate the model’s performance. If the output 614 is not sufficiently accurate or safe, this performance feedback may be used by the model training host 602 to further train the model using the ST scene representation and query-conditioned approach, aiming to improve its planning capabilities. The updated model may then be deployed to the model inference host 604.

In certain aspects, the model training host 602 may be deployed at or with the same or a different entity than that in which the model inference host 604 is deployed. For example, in order to offload model training processing, which can impact the performance of the model inference host 604, the model training host 602 may be deployed at a model server as further described herein. Further, in some cases, training and/or inference may be distributed amongst devices in a decentralized or federated fashion.

In some aspects, a machine learning model utilizing the ST scene representation and/or query-conditioned approach is deployed at or on a computing device for enhancing the performance of trajectory planning tasks. More specifically, a model inference host, such as model inference host 604 in FIG. 6, may be deployed at or on the computing device for running the trajectory planning model to generate accurate and safe trajectories.

In some other aspects, the ST scene and query-conditioned machine learning model is deployed at or on an embedded system, mobile robot, or other device for enabling efficient on-device trajectory planning. More specifically, a model inference host, such as model inference host 604 in FIG. 6, may be deployed at or on the embedded system, mobile robot, or other device for running the model to obtain high-quality trajectories while meeting resource constraints.

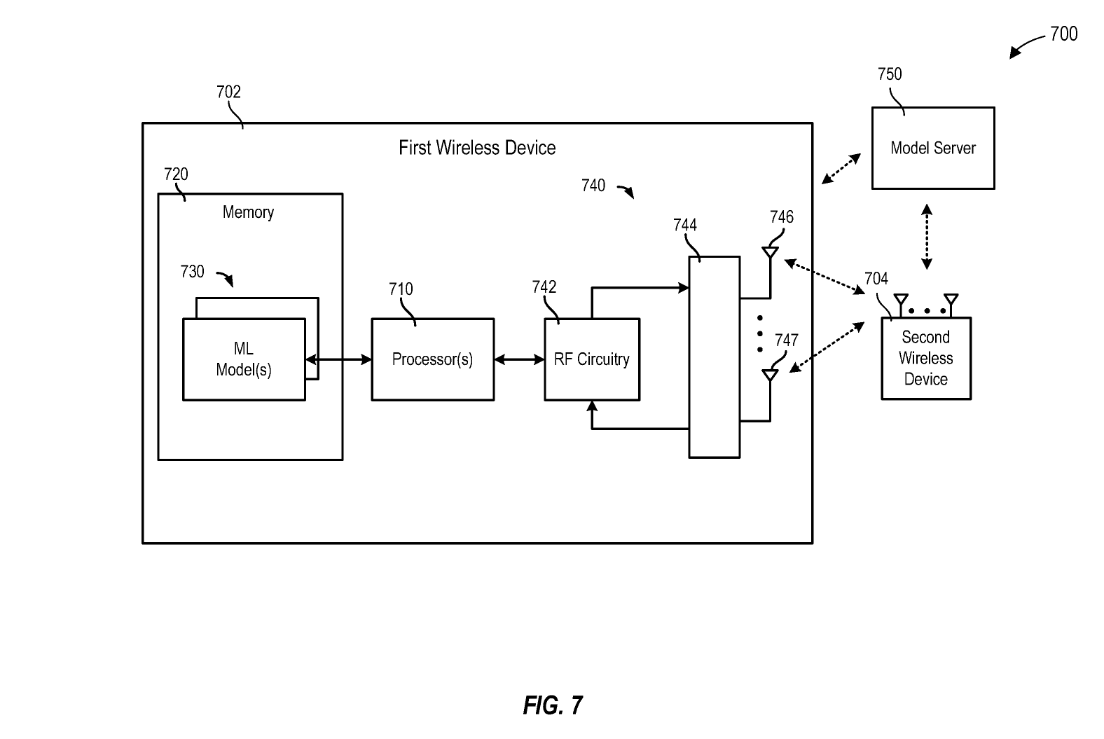

FIG. 7 illustrates an example AI architecture 700 of a first computing device 702 that is in communication with a second computing device 704. The first computing device 702 may be a server or cloud computing platform as described herein with respect to FIG. 6. Similarly, the second computing device 704 may be an embedded system or mobile device as described herein with respect to FIG. 6. Note that the AI architecture of the first computing device 702 may be applied to the second computing device 704.

The first computing device 702 may be, or may include, a chip, system on chip (SoC), a system in package (SiP), chipset, package or device that includes one or more processors, processing blocks or processing elements (collectively “the processor 710”) and one or more memory blocks or elements (collectively “the memory 720”).

As an example, in a model inference mode, the processor 710 may transform input data (e.g., images, sensor readings) into a format suitable for the trajectory planning model, such as the ST scene representation. The processor 710 may then run the model on the formatted input data to generate an output trajectory. The processor 710 may be coupled to a transceiver 740 for transmitting the output trajectory to and/or receiving input data from one or more connected devices 746. The transceiver 740 includes interface circuitry 742 and 744 for converting between the digital signals of the processor and any transmission protocol used by the connected devices 746. The connected devices 746 may be sensors, actuators, displays, or storage that provide input to or consume the output from the model.

When receiving input data via the connected devices 746 (e.g., from the second computing device 704), the transceiver interface circuitry 742 and 744 may convert the received signals to a baseband frequency and then to digital signals for processing by the processor 710. The processor 710 may format the digital input signals and feed them into the trajectory planning model for inference.

One or more ML models 730 may be stored in the memory 720 and accessible to the processor(s) 710. In certain cases, different ML models 730 with different characteristics may be stored in the memory 720, and a particular ML model 730 may be selected based on its characteristics and/or application as well as characteristics and/or conditions of first wireless device 702 (e.g., a power state, a mobility state, a battery reserve, a temperature, etc.). For example, the ML models 730 may have different inference data and output pairings (e.g., different types of inference data produce different types of output), different levels of accuracies (e.g., 80%, 90%, or 95% accurate) associated with the predictions (e.g., the output 614 of FIG. 6), different latencies (e.g., processing times of less than 10 ms, 100 ms, or 1 second) associated with producing the predictions, different ML model sizes (e.g., file sizes), different coefficients or weights, etc.

The processor 710 may use the ML model 730 to produce output data (e.g., the output 614 of FIG. 6) based on input data (e.g., the inference data 612 of FIG. 6), for example, as described herein with respect to the inference host 604 of FIG. 6. The ML model 730 may be used to perform any of various AI-enhanced tasks, such as those listed above.

As an example, the ML model 730 may take an ST scene representation as input to predict a trajectory using one or more example query-conditioned techniques previously described. The input data may include, for example, the spatio-temporal relationships between the ego agent and other agents in the environment, encoded in the ST scene format. The output data may include, for example, a complete and accurate trajectory for the ego agent to follow, which is obtained by applying the query-conditioned approach within the model. In certain aspects, the output trajectory may be considered a “virtual” result in that it is not directly measured but rather inferred by the model based on the input observations and the learned planning dynamics. In other cases, the output trajectory may correspond to a physical path that is feasible in principle but not directly observed by the sensors available to the system. Note that other input data and/or output data may be used in addition to or instead of the examples described herein, depending on the specific planning task and the available sensors. In certain aspects, a model server 750 may perform any of various ML model lifecycle management (LCM) tasks for the first wireless device 702 and/or the second wireless device 704. The model server 750 may operate as the model training host 602 and update the ML model 730 using training data. In some cases, the model server 750 may operate as the data source 606 to collect and host training data, inference data, and/or performance feedback associated with an ML model 730.

In certain aspects, the model server 750 may host various types and/or versions of the ML models 730 for the first wireless device 702 and/or the second wireless device 704 to download. In some cases, the model server 750 may monitor and evaluate the performance of the ML model 730 that utilizes the ST scene representation and/or query-conditioned approach to trigger one or more lifecycle management (LCM) tasks. For example, the model server 750 may determine whether to activate or deactivate the use of a particular trajectory planning model at the first computing device 702 and/or the second computing device 704, based on factors such as the accuracy requirements, computational budget, and energy constraints of each device. The model server 750 may then provide instructions to the respective devices to manage their model usage accordingly.

In some cases, the model server 750 may determine whether to switch to a different variant of the ST scene and query-conditioned ML model 730 at the first computing device 702 and/or the second computing device 704, based on changes in the operating conditions or performance objectives. For instance, the model server may instruct a device to switch from a complex model with high accuracy to a simpler model with lower latency when the battery level falls below a threshold. In yet further examples, the model server 750 may act as a central coordinator for collaborative learning of trajectory planning models across multiple devices, using techniques such as federated learning to train a global model from locally-computed updates while preserving data privacy.

### Example Artificial Intelligence Model

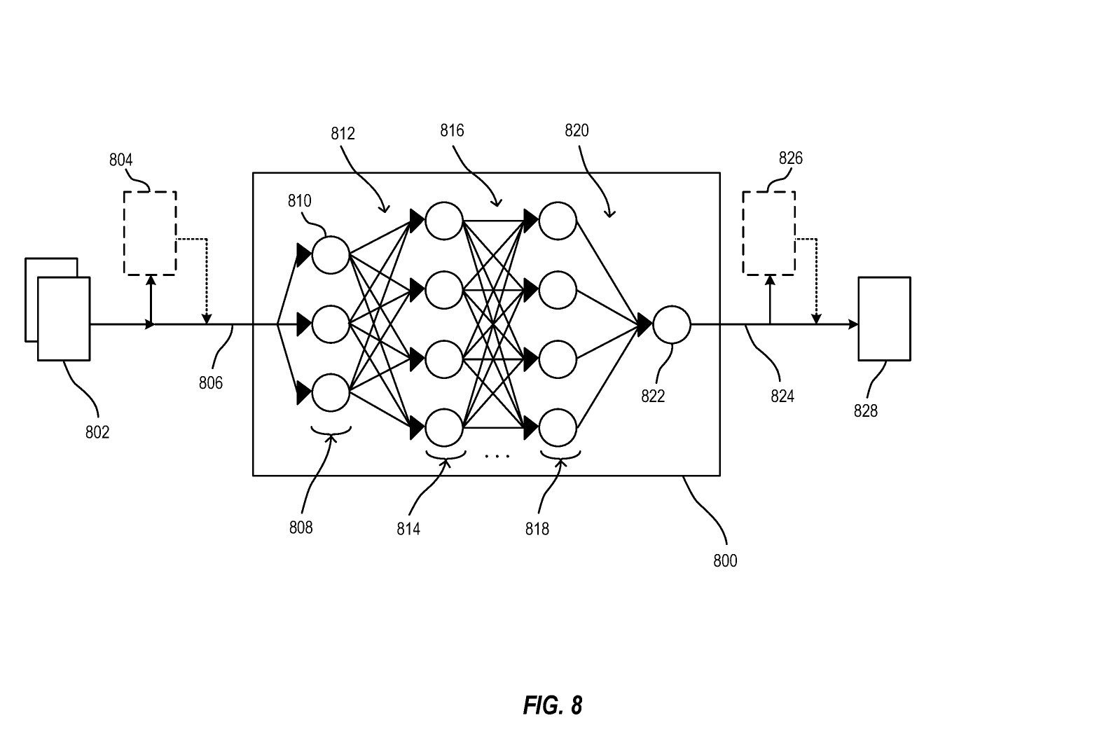

FIG. 8 is an illustrative block diagram of an example artificial neural network (ANN) 800 that may be used to implement one or more trajectory planning models in accordance with examples of the present disclosure. ANN 800 may receive input data 806 which may include one or more bits of data 802, pre-processed data output from pre-processor 804 (optional), or some combination thereof. Here, data 802 may include training data, verification data, application-related data, or the like, e.g., depending on the stage of development and/or deployment of ANN 800. Pre-processor 804 may be included within ANN 800 in some other implementations. Pre-processor 804 may, for example, process all or a portion of data 802 which may result in some of data 802 being changed, replaced, deleted, etc. In some implementations, pre-processor 804 may add additional data to data 802.

ANN 800 includes at least one first layer 808 of artificial neurons 810 (e.g., perceptrons) to process input data 806 and provide resulting first layer output data via edges 812 to at least a portion of at least one second layer 814. Second layer 814 processes data received via edges 812 and provides second layer output data via edges 816 to at least a portion of at least one third layer 818. Third layer 818 processes data received via edges 816 and provides third layer output data via edges 820 to at least a portion of a final layer 822 including one or more neurons to provide output data 824. All or part of output data 824 may be further processed in some manner by (optional) post-processor 826. Thus, in certain examples, ANN 800 may provide output data 828 that is based on output data 824, post-processed data output from post-processor 826, or some combination thereof. Post-processor 826 may be included within ANN 800 in some other implementations. Post-processor 826 may, for example, process all or a portion of output data 824 which may result in output data 828 being different, at least in part, to output data 824, e.g., as result of data being changed, replaced, deleted, etc. In some implementations, post-processor 826 may be configured to add additional data to output data 824. In this example, second layer 814 and third layer 818 represent intermediate or hidden layers that may be arranged in a hierarchical or other like structure. Although not explicitly shown, there may be one or more further intermediate layers between the second layer 814 and the third layer 818.

The structure and training of artificial neurons 810 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 612 in FIG. 6). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 800 and a number of layers and a number of artificial neurons in each layer, as well as selecting activation functions, a loss function, training processes, etc. Once an initial model has been designed, training of the model may be conducted using training data. Training data may include one or more datasets within which ANN 800 may detect, determine, identify or ascertain patterns. Training data may represent various types of information, including sensor data, environment information, agent behaviors, etc. During training, parameters of artificial neurons 810 may be changed, such as to minimize or otherwise reduce a loss function or a cost function. A training process may be repeated multiple times to fine-tune ANN 800 with each iteration.

Various ANN model structures are available for consideration in the context of trajectory planning. For example, a convolutional neural network (CNN) structure may be used to process the ST scene representation and extract relevant features for trajectory prediction. The convolutional layers in the CNN can learn to capture spatial and temporal patterns in the input data, such as the relationships between the ego agent and other agents over time. The output of the CNN may be fed into a fully connected network (FCN) to generate the estimated trajectory. In a recurrent neural network (RNN) structure, such as a long short-term memory (LSTM) network, the model can process sequential data and learn to capture temporal dependencies. This can be particularly useful for modeling the dynamic behavior of agents in the environment and predicting their future trajectories. The ST scene representation can be flattened into a sequence of vectors and fed into the RNN at each time step, allowing the model to reason about the evolution of the scene over time.

A transformer structure, which relies on attention mechanisms, can also be applied to trajectory planning. The self-attention layers in the transformer can learn to attend to relevant parts of the input sequence, such as the interactions between the ego agent and other agents, and generate context-aware representations for trajectory prediction. The query-conditioned approach can be implemented by providing the query as an additional input to the transformer, guiding the model to focus on the relevant aspects of the scene for the given task.

Other ANN structures, such as graph neural networks (GNNs) or generative models like variational autoencoders (VAEs) or generative adversarial networks (GANs), may also be explored for trajectory planning. GNNs can naturally handle the graph-like structure of the ST scene, while generative models can be used to sample diverse and plausible trajectories.

ANN 800 or other ML models may be implemented in various types of processing circuits along with memory and applicable instructions therein, for example, as described herein with respect to FIGS. 6 and 7. For example, general-purpose hardware circuits, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 800 of FIG. 8, for trajectory planning.

As part of the development process for machine learning models that utilize the ST scene representation and a query-conditioned approach, relevant training data must be gathered or generated. For example, training data may include sensor data from autonomous vehicles, robots, or devices, along with corresponding ground truth trajectories. This data can be used to train the model to accurately predict trajectories for the given task. In certain instances, the training data may originate from real-world deployments, simulations, or public datasets. Data augmentation techniques, such as adding noise or applying transformations, can be used to increase the diversity of the training data and improve model robustness. For example, crowdsourcing platforms or online databases may be leveraged to gather diverse examples for training propagation-guided models. In another example, training data may be generated synthetically using simulation engines or generative models to augment real-world samples. The training data collection process can be performed offline, resulting in a static dataset for batch training, or online, where new samples are continuously incorporated into the model training pipeline. For example, an embedded system may periodically upload new training samples gathered during operation to a server, which then fine-tunes the propagation-enhanced model using online learning techniques. For offline training, data collection and model updates can occur at a central location (e.g., a datacenter) or be distributed across multiple nodes (e.g., a sensor network). For online training, the model may be adapted locally on each device or by a remote server that receives streaming data from the devices.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model’s performance to baseline or other benchmark information. If model performance is deemed unsatisfactory, it may be beneficial to fine-tune the model, e.g., by changing its architecture, re-training it on the data, or using different optimization techniques, etc. Once a model’s performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 800 of FIG. 8, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training of machine learning models that utilize the ST scene representation and query-conditioned approach on data distributed across multiple devices or organizations, without the need to centralize the data or the training process. Federated learning is particularly useful when the training data is sensitive or subject to privacy constraints, or when it is impractical, inefficient, or expensive to gather all the data in one place. In the context of trajectory planning, for example, federated learning may be used to improve model performance by allowing it to learn from a wide range of environments and conditions. For instance, a trajectory planning model may be trained on data collected from a large number of autonomous vehicles or robots, each with its own sensor configuration and operating domain, to improve its robustness and generalization. With federated learning, each device may receive a copy of the model and perform local training using its own data to capture device-specific patterns. The devices then send only the updated model parameters (e.g., weights and biases) to a central server, without revealing the raw data. The server aggregates the contributions from all devices and updates the global model, which is then redistributed to the devices for the next round of local training. This process is repeated iteratively until the trajectory planning model achieves satisfactory performance across all participating devices. By enabling collaborative learning while keeping data localized, federated learning allows the development of powerful trajectory planning models that can leverage diverse datasets without compromising privacy or security.

In some implementations, one or more devices or services may support processes relating to the usage, maintenance, activation, and reporting of machine learning models that utilize the ST scene representation and query-conditioned approach. In certain instances, all or part of the training data or the trained model may be shared across multiple devices to provide or improve the trajectory planning capabilities. For example, an autonomous vehicle with a rich sensor suite may share its data with a delivery robot having only a camera and GPS, enabling the latter to train a trajectory planning model using the ST scene representation. In some cases, signaling mechanisms may be employed to communicate the capabilities and requirements for performing specific functions related to trajectory planning models, such as the supported input and output formats, the available computational resources, or the ability to collect and share training data. These models may be used to support various applications, such as autonomous driving, robotics, or drone navigation, where accurate and efficient trajectory planning is crucial. The deployment of trajectory planning models may occur at different levels of a system architecture, such as on individual devices (e.g., vehicles, robots), edge servers (e.g., base stations, access points), or cloud platforms, depending on factors such as latency requirements, data privacy concerns, and resource availability. By leveraging the ST scene representation and query-conditioned approach, these models can provide high-quality trajectories while operating under the constraints of each deployment scenario.

### Example Operations for Performing Trajectory Planning for an Object

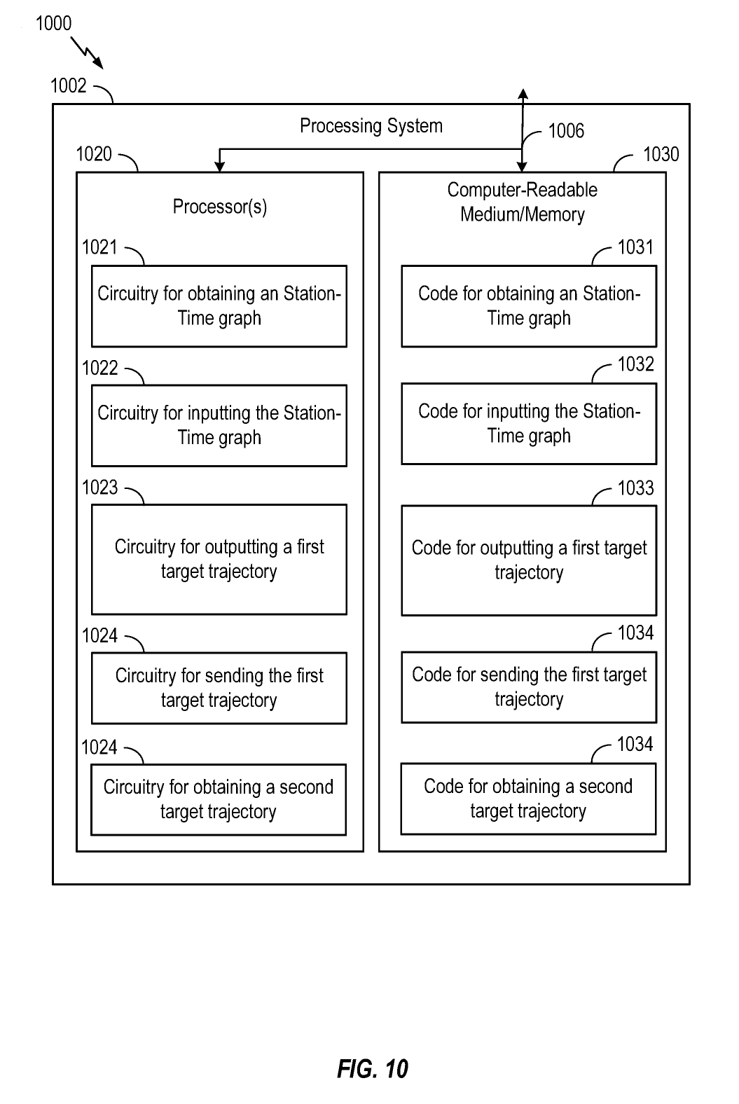

In one aspect, method 900, or any aspect related to it, may be performed by an apparatus, such as processing system 1000 of FIG. 10, which includes various components operable, configured, or adapted to perform the method 900.

Method 900 begins at 902 obtaining an ST scene. In some aspects, the ST scene represents 1) a displacement of one or more agents over time with respect to a reference point corresponding to a current position of the object and 2) a target location of the object.

Method 900 may then proceed to 904 with inputting the ST scene into a first machine learning model.

Method 900 may then proceed to 906 with outputting, by the first machine learning model, based on the input ST scene, a first target trajectory for the object to follow to occupy the target location.

Method 900 may then proceed to 908 with sending the first target trajectory to a second machine learning model.

Method 900 may then end at 910 with obtaining, from the second machine learning model, a second target trajectory for the object to follow to occupy the target location.

In some aspects of method 900, the ST scene comprises a grid of cells, each cell of the grid of cells corresponding to a discrete displacement from the reference point at a discrete time.

In some aspects of method 900, each of one or more cells of the grid of cells is associated with a respective vector of features comprising one or more of: a respective indication of a speed of at least one agent of the one or more agents associated with the cell; a respective indication of a future state of the at least one agent associated with the cell; a respective indication of the at least one agent associated with the cell; a respective indication of at least one of a position, velocity, acceleration, or orientation of the object associated with the cell; a respective indication of at least one type of occlusion; or a respective indication of whether the cell is associated with the target location.

In some aspects, method 900 further comprises: receiving sensor data comprising information about the object and the one or more agents; and generating, for each cell of the grid of cells, the respective vector of features based on the sensor data.

In some aspects of method 900, the one or more sensors are configured to generate the sensor data comprising at least one of: one or more images, one or more point clouds, one or more coordinates, or one or more velocities.

In some aspects of method 900, the one or more sensors are integrated into the object.

In some aspects of method 900, each of one or more second cells of the grid of cells is associated with a default value indicating an absence of features.

In some aspects of method 900, obtaining the ST scene comprises: obtaining one or more trajectories for the one or more agents; obtaining the target location of the object; obtaining the current position of the object; and generating the ST scene based on the one or more trajectories for the one or more agents, the target location of the object, and the current position of the object.

In some aspects of method 900, obtaining the ST scene comprises: obtaining one or more trajectories for the one or more agents; obtaining the target location of the object; obtaining the current position of the object; and generating the ST scene based on the one or more trajectories for the one or more agents, the target location of the object, and the current position of the object.

In some aspects of method 900, generating the ST scene comprises compressing the ST scene by removing one or more empty cells.

In some aspects of method 900, generating the ST scene is based on at least one environmental occlusion.

In some aspects of method 900, the object comprises a vehicle and the second machine learning model is a planning algorithm for autonomous vehicle decision-making.

In some aspects, method 900 further comprises: obtaining a plurality of ST scenes, each ST scene corresponding to a different driving scenario; and training the first machine learning model using the plurality of ST scenes.

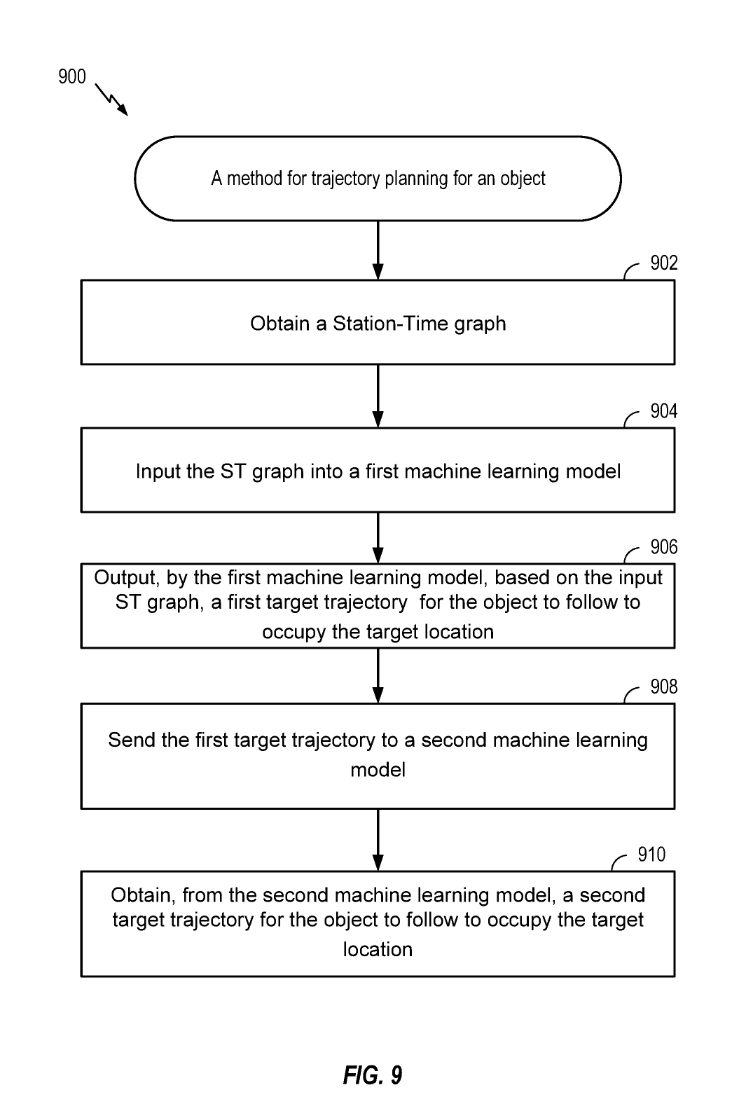

Note that FIG. 9 is just one example of a method, and other methods including fewer, additional, or alternative steps are possible consistent with this disclosure.

### Example Processing System for Performing Trajectory Planning for an Object

FIG. 10 depicts aspects of an example processing system 1000.

The processing system 1000 includes a processing system 1002 includes one or more processors 1020. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the method 900 described with respect to FIG. 9, or any aspect related to it, including any additional steps or sub-steps described in relation to FIG. 9.

In the depicted example, computer-readable medium/memory 1030 stores code (e.g., executable instructions) for obtaining an ST scene 1031, code for inputting the ST scene into a first machine learning model 1032, code for outputting, by the first machine learning model, based on the input ST scene, a first target trajectory for the object to follow to occupy the target location 1033, code for sending the first target trajectory to a second machine learning model 1034, and code for obtaining, from the second machine learning model, a second target trajectory for the object to follow to occupy the target location 1035. Processing of the code 1031-1035 may enable and cause the processing system 1000 to perform the method 900 described with respect to FIG. 9, or any aspect related to it.

The one or more processors 1020 include circuitry configured to implement (e.g., execute) the code stored in the computer-readable medium/memory 1030, including circuitry for obtaining an ST scene 1021, circuitry for inputting the ST scene into a first machine learning model 1022, circuitry for outputting, by the first machine learning model, based on the input ST scene, a first target trajectory for the object to follow to occupy the target location 1023, circuitry for sending the first target trajectory to a second machine learning model 1024, and circuity for obtaining, from the second machine learning model, a second target trajectory for the object to follow to occupy the target location 1025. Processing with circuitry 1021-1025 may enable and cause the processing system 1000 to perform the method 900 described with respect to FIG. 9, or any aspect related to it.

### Example Clauses

Implementation examples are described in the following numbered clauses:

Clause 1: A method for performing trajectory planning for an object, comprising: obtaining an ST scene representing 1) a displacement of one or more agents over time with respect to a reference point corresponding to a current position of the object and 2) a target location of the object; inputting the ST scene into a first machine learning model; outputting, by the first machine learning model, based on the input ST scene, a first target trajectory for the object to follow to occupy the target location; sending the first target trajectory to a second machine learning model; and obtaining, from the second machine learning model, a second target trajectory for the object to follow to occupy the target location.

Clause 2: A method according to Clause 1, wherein the ST scene comprises a grid of cells, each cell of the grid of cells corresponding to a discrete displacement from the reference point at a discrete time.

Clause 3: A method according to Clause 2, wherein each of one or more cells of the grid of cells is associated with a respective vector of features comprising one or more of: a respective indication of a speed of at least one agent of the one or more agents associated with the cell; a respective indication of a future state of the at least one agent associated with the cell; a respective indication of the at least one agent associated with the cell; a respective indication of at least one of a position, velocity, acceleration, or orientation of the object associated with the cell; a respective indication of at least one type of occlusion; or a respective indication of whether the cell is associated with the target location.

Clause 4: A method according to Clause 3, further comprising: receiving sensor data comprising information about the object and the one or more agents; and generating, for each cell of the grid of cells, the respective vector of features based on the sensor data.

Clause 5: A method according to Clause 4, further comprising one or more sensors, coupled to the one or more processors, wherein the one or more sensors are configured to generate the sensor data comprising at least one of: one or more images, one or more point clouds, one or more coordinates, or one or more velocities.

Clause 6: A method according to Clause 5, wherein the one or more sensors are integrated into an object.

Clause 7: A method according to any one of Clauses 3-6, wherein each of one or more second cells of the grid of cells is associated with a default value indicating an absence of features.

Clause 8: A method according to any one of Clauses 1-7, wherein obtaining the ST scene comprises: obtaining one or more trajectories for the one or more agents; obtaining the target location of the object; obtaining the current position of the object; and generating the ST scene based on the one or more trajectories for the one or more agents, the target location of the object, and the current position of the object.

Clause 9: A method according to Clause 8, wherein generating the ST scene comprises: compressing the ST scene by removing one or more empty cells.

Clause 10: A method according to Clause 8, wherein the ST scene is based on at least one environmental occlusion.

Clause 11: A method according to any one of Clauses 1-10, wherein the object comprises a vehicle and the second machine learning model is a planning algorithm for autonomous vehicle decision-making.

Clause 12: A method according to any one of Clauses 1-11, further comprising: obtaining a plurality of ST scenes, each ST scene corresponding to a different driving scenario; and training the first machine learning model using the plurality of ST scenes.

Clause 13: One or more apparatuses, comprising: one or more memories comprising executable instructions; and one or more processors configured to execute the executable instructions and cause the one or more apparatuses to perform a method in accordance with any one of clauses 1-12.

Clause 14: One or more apparatuses, comprising: one or more memories; and one or more processors, coupled to the one or more memories, configured to cause the one or more apparatuses to perform a method in accordance with any one of Clauses 1-12.

Clause 15: One or more apparatuses, comprising: one or more memories; and one or more processors, coupled to the one or more memories, configured to perform a method in accordance with any one of Clauses 1-12.

Clause 16: One or more apparatuses, comprising means for performing a method in accordance with any one of Clauses 1-12.

Clause 17: One or more non-transitory computer-readable media comprising executable instructions that, when executed by one or more processors of one or more apparatuses, cause the one or more apparatuses to perform a method in accordance with any one of Clauses 1-12.

Clause 18: One or more computer program products embodied on one or more computer-readable storage media comprising code for performing a method in accordance with any one of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for trajectory planning for an object, comprising:
one or more memories configured to store information corresponding to a station-time (ST) scene representing 1) a displacement of one or more agents over time with respect to a reference point corresponding to a current position of the object and 2) a target location of the object; and
one or more processors, coupled to the one or more memories, configured to:
obtain the ST scene;
input the ST scene into a first machine learning model;
output, by the first machine learning model, based on the input ST scene, a first target trajectory for the object to follow to occupy the target location;
send the first target trajectory to a second machine learning model; and
obtain, from the second machine learning model, a second target trajectory for the object to follow to occupy the target location.

2. The apparatus of claim 1, wherein the ST scene comprises a grid of cells, each cell of the grid of cells corresponding to a discrete displacement from the reference point at a discrete time.

3. The apparatus of claim 2, wherein each of one or more cells of the grid of cells is associated with a respective vector of features comprising one or more of:
a respective indication of a speed of at least one agent of the one or more agents associated with the cell;
a respective indication of a future state of the at least one agent associated with the cell;
a respective indication of the at least one agent associated with the cell;
a respective indication of at least one of a position, velocity, acceleration, or orientation of the object associated with the cell;
a respective indication of at least one type of occlusion; or
a respective indication of whether the cell is associated with the target location.

4. The apparatus of claim 3, wherein the one or more processors are configured to:
receive sensor data comprising information about the object and the one or more agents; and
generate, for each cell of the grid of cells, the respective vector of features based on the sensor data.

5. The apparatus of claim 4, further comprising one or more sensors, coupled to the one or more processors, wherein the one or more sensors are configured to generate the sensor data comprising at least one of: one or more images, one or more point clouds, one or more coordinates, or one or more velocities.

6. The apparatus of claim 5, wherein the one or more sensors are integrated into the object.

7. The apparatus of claim 3, wherein each of one or more second cells of the grid of cells is associated with a default value indicating an absence of features.

8. The apparatus of claim 1, wherein to obtain the ST scene, the one or more processors are configured to:
obtain one or more trajectories for the one or more agents;
obtain the target location of the object;
obtain the current position of the object; and
generate the ST scene based on the one or more trajectories for the one or more agents, the target location of the object, and the current position of the object.

9. The apparatus of claim 8, wherein to generate the ST scene, the one or more processors are configured to:
compress the ST scene by removing one or more empty cells.

10. The apparatus of claim 8, wherein the ST scene is based on at least one environmental occlusion.

11. The apparatus of claim 1, wherein the object comprises a vehicle and the second machine learning model is a planning algorithm for autonomous vehicle decision-making.

12. The apparatus of claim 1, wherein the one or more processors are configured to:
obtain a plurality of ST scenes, each ST scene corresponding to a different driving scenario; and
train the first machine learning model using the plurality of ST scenes.

13. A method for performing trajectory planning for an object, comprising:
obtaining an ST scene representing 1) a displacement of one or more agents over time with respect to a reference point corresponding to a current position of the object and 2) a target location of the object;
inputting the ST scene into a first machine learning model;
outputting, by the first machine learning model, based on the input ST scene, a first target trajectory for the object to follow to occupy the target location;
sending the first target trajectory to a second machine learning model; and
obtaining, from the second machine learning model, a second target trajectory for the object to follow to occupy the target location.

14. The method of claim 13, wherein the ST scene comprises a grid of cells, each cell of the grid of cells corresponding to a discrete displacement from the reference point at a discrete time.

15. The method of claim 14, wherein each of one or more cells of the grid of cells is associated with a respective vector of features comprising one or more of:
a respective indication of a speed of at least one agent of the one or more agents associated with the cell;
a respective indication of a future state of the at least one agent associated with the cell;
a respective indication of the at least one agent associated with the cell;
a respective indication of at least one of a position, velocity, acceleration, or orientation of the object associated with the cell; or
a respective indication of whether the cell is associated with the target location.

16. The method of claim 15, further comprising:
receiving sensor data comprising information about the object and the one or more agents; and
generating, for each cell of the grid of cells, the respective vector of features based on the sensor data.

17. The method of claim 13, wherein obtaining the ST scene comprises:
obtaining one or more trajectories for the one or more agents; obtaining the target location of the object;
obtaining the current position of the object; and
generating the ST scene based on the one or more trajectories for the one or more agents, the target location of the object, and the current position of the object.

18. The method of claim 13, wherein the object comprises a vehicle and the second machine learning model comprises a planning algorithm for autonomous vehicle decision-making.

19. The method of claim 13, further comprising:
obtaining a plurality of ST scenes, each ST scene corresponding to a different driving scenario; and
training the first machine learning model using the plurality of ST scenes.

20. A non-transitory computer-readable medium comprising instructions, which when executed by one or more processors, cause the one or more processors to perform operations for trajectory planning for an object, the operations comprising:
obtaining an ST scene representing 1) a displacement of one or more agents over time with respect to a reference point corresponding to a current position of the object and 2) a target location of the object;
inputting the ST scene into a first machine learning model;
outputting, by the first machine learning model, based on the input ST scene, a first target trajectory for the object to follow to occupy the target location;
sending the first target trajectory to a second machine learning model; and
obtaining, from the second machine learning model, a second target trajectory for the object to follow to occupy the target location.
